(19) United States
(12) Patent Application Publication
(10) Pub. No.: US 2003/0147988 A1
(43) Pub. Date: Aug. 7, 2003

(54) Die clamping unit of an injection molding machine

(75) Inventors: Takaki Miyauchi, Numazu-shi (JP); Kazuhito Kobayashi, Numazu-shi (JP); Yasuo Saitsu, Numazu-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/358,308

(22) Filed: Feb. 5, 2003

(30) Foreign Application Priority Data
Feb. 6, 2002 (JP) 2002-029832

(51) Int. Cl. B29C 45/66

(52) U.S. Cl. 425/589; 425/592; 425/593

(57) ABSTRACT

A stationary platen and link housing are coupled through tie bars and feed screw mechanisms are provided at connection areas between the tie bars and the link housing. A geared motor is mounted on a lower side of the link housing and a first spur gear is mounted at a back side of the link housing. A drive shaft of the geared motor and shaft of the first spur gear are connected through a combination of sprockets and chain. A ring gear is mounted at a center of the back face of the link housing and the first gear is engaged with the ring gear. Each second spur gear is fixed to a back face of a corresponding nut of the feed screw mechanism and connected through a corresponding idle gear to the ring gear.

### CROSS-REFERENCE TO RELATED APPLICATIONS

This application is based upon and claims the benefit of priority from the prior Japanese Patent Application No. 2002-029832, filed Feb. 6, 2002, the entire contents of which are incorporated herein by reference.

### BACKGROUND OF THE INVENTION

1. Field of the Invention

The present invention relates to a die clamping unit of an injection molding machine. In particular, the present invention relates to a so-called die thickness adjusting device configured to adjust a distance between a housing, supporting a movable platen from a back side, and a stationary platen.

2. Description of the Related Art

FIGS. 2A and 2B show one example of a conventional toggle-type die clamping unit.

A stationary platen 1 and movable platen 2 are arranged opposite each other. A stational die 3 is mounted to a front face of the stationary platen 1 while a movable die 4 is mounted to a front face of the movable platen 2. A link housing 5 is arranged at a back side of the movable platen 2.

The stationary platen 1 and link housing 5 are coupled to each other through four tie bars 6. The tie bars 6 extend through four near-corner portions of the movable platen 2. One end of the tie bar is fixed to the stationary platen 1 while the other end portion of the tie bar is connected through a feed screw mechanism to the link housing 5. That is, a male thread 8 is provided on an area of each tie bar 6 where it passes through the link housing 5 and a nut 9 is fitted over the respective male thread 8 of the corresponding tie bar. Each nut 9 is so retained as to be rotatable at the back side of the link housing 5. By driving each nut 9 at the same speed, the link housing 5 is moved forward or backward relative to the stationary platen 1 to allow a distance therebetween to be adjusted.

A toggle mechanism 7 is mounted to a front face of the link housing 5 and the movable platen 2 is connected to the link housing 5 through the toggle mechanism 7. The toggle mechanism 7 comprises a ball screw 72, a crosshead 73, toggle links 74, etc. The ball screw serves as a drive source. By moving the crosshead 73 forward or backward in an axial direction with the use of the ball screw 72, the toggle links 74 are stretched or contracted and the movable platen 2 is moved forward or backward to close or open the dies.

Upon the clamping of the dies, the dies are matched immediately before the toggle mechanism 7 is stretched to a full extent and, after this, the toggle mechanism 7 is further stretched to produce a die clamping force. A force exerted by the ball screw 72 is enlarged, by the toggle mechanism, severalfold and applied to the dies 3 and 4. The reaction force corresponding to the die clamping force acts upon the tie bars.

In order to effectively utilize the clamping force enlarging function by the toggle mechanism 7 in the above-mentioned toggle-type die clamping unit, it is necessary that the distance between the link housing 5 and the stationary platen 1 be initially adjusted to an appropriate value in accordance with the thickness of the dies. As set out above, such an adjusting operation is made by driving each feed screw mechanism, provided at the connection area between the link housing 5 and the respective tie bar, at the same speed.

In the example shown in FIGS. 2A and 2B, in order to drive the respective nut 9 of the feed screw mechanism at the same speed, connection is made, through one common chain 23, between the respective nut 9 and a geared motor 21 serving as its drive source, as follows. That is, the geared motor 21 is mounted on the lower side of the link housing 5. A first sprocket 22 is fixed to a drive shaft of the geared motor 21 and second sprockets 24 are each fixed to the back face of the respective nut 2. One common chain 23 is run around an array of the first sprocket 22 and four second sprockets 24.

FIGS. 3A and 3B to FIGS. 5A and 5B show other examples of structures of a drive force transmitting mechanism between respective nuts and their drive source in the conventional toggle-type die clamping unit.

In the example shown in FIGS. 3A and 3B, connection is made, through one common ring gear 37, between respective nuts 9 of a feed screw mechanism and a geared motor 31 serving as their drive source, as follows. That is, the geared motor 31 is mounted on a lower side of a link housing 5. The ring gear 37 is rotatably mounted at a center of the back face of the link housing 5. A first spur gear 35 is fixed to a drive shaft of the geared motor 31 and connection is made between the spur gear 35 and the ring gear 37 through an idle gear 36. Second spur gears 39 are each fixed to a back face of the corresponding nut 2 and each second spur gear 39 is directly engaged with the ring gear 37.

In the example shown in FIGS. 4A and 4B, connection is made, through one common ring gear 47, between each nut 9 of the feed screw mechanism and a geared motor 41 serving as its drive source, as follows. That is, the geared motor 41 is mounted on a back face side of the link housing 5 so as to be projected toward the back side of the link housing 5. The ring gear 47 is rotatably mounted at a center of the back face of the link housing 5. A first spur gear 45 is fixed directly to a drive shaft of the gear motor 41 and directly engaged with the ring gear 47. A second spur gear 49 is fixed to the back face of each nut 2 and each second spur gear 49 is connected to the ring gear 47 through a corresponding idle gear 48.

In an example shown in FIGS. 5A and 5B, connection is made, through one common ring gear 57, between each nut 9 of the feed screw mechanism and a geared motor 51 serving as its drive source as follows. That is, the geared motor 51 is mounted on the lower side of a link housing 5. The ring gear 57 is rotatably mounted at a center of the back face of the link housing 5. A first spur gear 55 is fixed to a drive shaft of the geared motor 51 and connection is made between the first spur gear 55 and the ring gear 57 through two idle gears 56a and 56b. A second spur gear 59 is fixed to the back face of the respective nut 9 and is connected to the ring gear 57 through a corresponding idle gear 58.

(Problem of the Conventional Drive Force Transmitting Mechanism)

(a) In the example shown in FIGS. 2A and 2B, one chain 23 is run around an array of four second sprockets 24 and a problem arises as will be set out below. That is, usually, the chain has such a property as to be elongated when a load acts upon it. If, in this case, a rotational torque uniformly acts upon the respective second sprockets 24, the load acting upon the chain 23 is stepwise decreased each time the chain is run past the respective second sprockets 24. For this reason, the elongation of the chain 23 varies between each of the second sprockets 24, and there occurs an undesired deviation in the rotation angle of the respective second sprockets 24.

(b) In the case of the example shown in FIGS. 3A and 3B, the diameter of the ring gear 37 is increased with an increase in the size of the die clamping unit and, therefore, the manufacturing cost of the ring gear 37 becomes higher. Further, the manufacturing difficulty of the ring gear 37 also rises.

(c) In the case of the example shown in FIGS. 4A and 4B, the diameter of the ring gear 47 can be made smaller than in the previous case (FIGS. 3A and 3B). However, the geared motor 41 is projected from behind the link housing 5 and the full length of the die clamping unit becomes greater.

(d) In the case of the example shown in FIGS. 5A and 5B, the diameter of the ring gear 57 can be made less than in the previous case shown in FIGS. 3A and 3B. However, the number of idle gears (56a, 56b, 58) is increased and an increasing manufacturing cost is incurred.

(e) In each of the above-mentioned cases shown in FIGS. 2A and 2B to FIGS. 5A and 5B, the speed reduction ratio “η” can be expressed by the following equation:

η=η1×η2

where

η1=the speed reduction ratio of the gear motor; and

η2=the number of teeth of the second spur gear/the number of teeth of the first spur gear.

Thus, when the value η2 is determined from the diameters of the first and second spur gears, then the value η1 is determined from which a target speed reduction ratio is obtained. Here, the diameters of the first and second spur gears are restricted by the size of the die clamping unit, drive torque, etc., of the nuts of the feed screw mechanism, and it is not possible to make the value η2 too large. It is, therefore, necessary to increase the speed reduction ratio η1 of the geared motor to a very high value. Since, however, such a geared motor having a greater speed reduction ratio is higher in cost, the manufacturing cost of a resultant die clamping unit is increased.

### BRIEF SUMMARY OF THE INVENTION

The present invention is achieved in view of the above-mentioned problems encountered in the die clamping unit of the conventional injection molding machine and accordingly it is the object of the present invention to provide a die clamping unit which can accurately match the driving speed of each feed screw mechanism, and reduce the manufacturing cost.

A die clamping unit of an injection molding machine according to the present invention comprises a stationary platen configured to retain a stationary die; a movable platen arranged opposite to the stationary platen and configured to retain a movable die; a housing arranged behind the movable platen and configured to support the movable platen from a back side through a loading device for die clamping; a plurality of tie bars coupled between the stationary platen and the hosing and each having one end fixed to the stationary platen and the other end portion having a male thread of a feed screw mechanism, each of the tie bars being connected to the housing through the feed screw mechanism; a plurality of nuts, each configured to be rotatably retained on the housing and fitted over the male thread to provide the feed screw mechanism; a motor supported on the housing; a first spur gear rotatably mounted to a back face of the housing; a chain configured to be run between a first sprocket fixed to a drive shaft of the motor and a second sprocket fixed to a shaft of the first spur gear, and transmit a rotation motion of the motor to the first spur gear; one ring gear rotatably mounted at a center of the back face of the housing and configured to be engaged with the first spur gear; a plurality of second spur gears, each fixed to the corresponding nut; and a plurality of idle gears, each provided between the ring gear and the second spur gear, and configured to transmit a rotation motion of the ring gear to the second spur gear.

According to the die clamping unit of the injection molding unit of the present invention, the housing is moved forward or backward relative to the stationary platen by driving the feed screw mechanisms provided at connection areas between the housing and the tie bars. At this time, the rotation motion of the motor serving as a drive source of the feed screw mechanisms is transmitted to the first spur gear through a combination of the first sprocket, chain and second sprocket and then from the first spur gear to each of the nuts of the feed screw mechanisms through the ring gear, respective idle gear and corresponding second spur gear.

By providing the drive power transmission path from the geared motor to the nuts of the feed screw mechanisms as set out above, it is possible to accurately drive each feed screw mechanism at the same speed. By making connection between the ring gear and each of the second spur gears through the corresponding idle gear, it is not necessary to enlarge the diameter of the ring gear and it is possible to reduce the manufacturing cost of the ring gear.

By making connection between the drive shaft of the geared motor and the shaft of the first spur gear through a combination of the paired sprockets and chain, a greater speed reduction ratio between the geared motor and the first spur gear can be obtained, thus it is not necessary to make the speed reduction ratio of the motor itself greater. It is thus possible to use a geared motor (or a simple motor without any speed reducer) of a relatively low cost and a smaller speed reduction ratio. Further, by making the above-mentioned connection through the chain, the motor can be arranged on the upper side, on the lower side or on the lateral side of the housing and, therefore, the full length of the die clamping unit is not increased.

### BRIEF DESCRIPTION OF THE SEVERAL VIEWS OF THE DRAWING

FIG. 1A is a left side view showing a schematic structure of a die clamping unit of an injection molding machine according to one embodiment of the present invention;

FIG. 1B is a front view showing a schematic structure of the die clamping unit of the injection molding machine according to the present invention;

FIG. 2A is a left side view showing one example of a drive force transmitting mechanism of a tie bar's feed screw in the die clamping unit of a conventional injection molding machine;

FIG. 2B is a front view showing the example of a drive force transmitting mechanism of the tie bar's feed screw in the die clamping unit of the conventional injection molding machine;

FIG. 3A is a left side view showing another example of a drive force transmitting mechanism of a tie bar's feed screw in a die clamping unit of a conventional injection molding machine;

FIG. 3B is a front view showing the example of the drive force transmitting mechanism of the tie bar's feed screw in the die clamping unit of the conventional injection molding machine;

FIG. 4A is a left side view showing another example of a drive force transmitting mechanism of a tie bar's feed screw in a die clamping unit of a conventional injection molding machine;

FIG. 4B is a front view showing the example of the drive force transmitting mechanism of the tie bar's feed screw in the die clamping unit of the conventional injection molding machine;

FIG. 5A is a left side view showing another example of a drive force transmitting mechanism of a tie bar's feed screw in a die clamping unit of a conventional injection molding machine; and

FIG. 5B is a front view showing the example of the drive force transmitting mechanism of the tie bar's feed screw in the die clamping unit of the conventional injection molding machine.

### DETAILED DESCRIPTION OF THE INVENTION

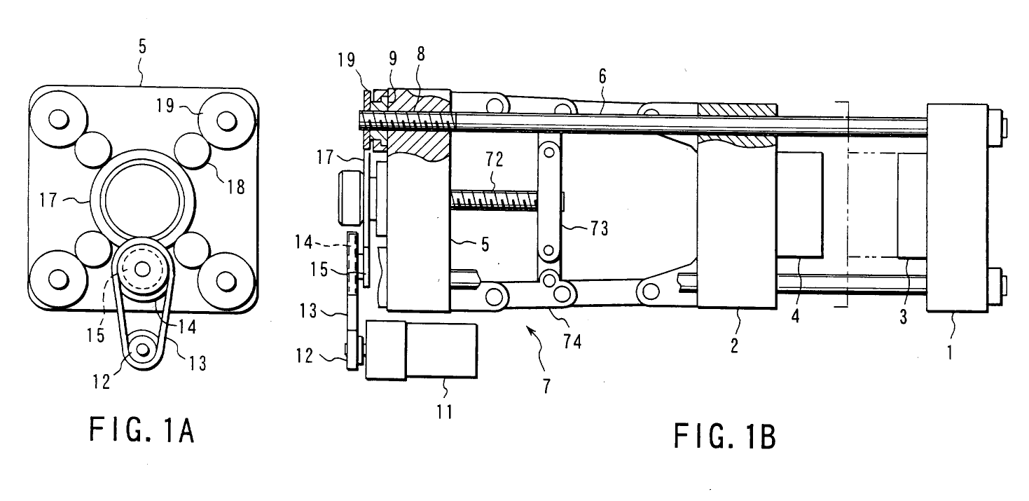

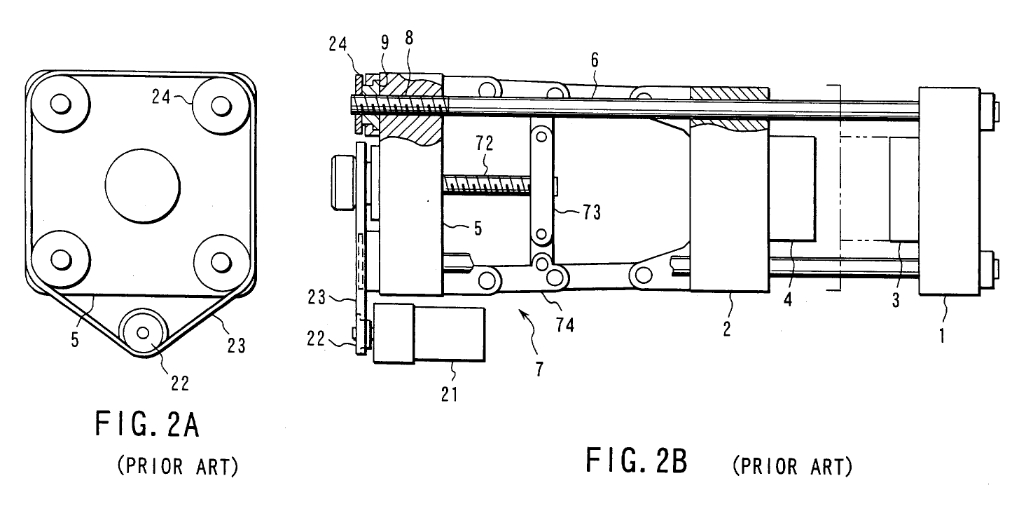

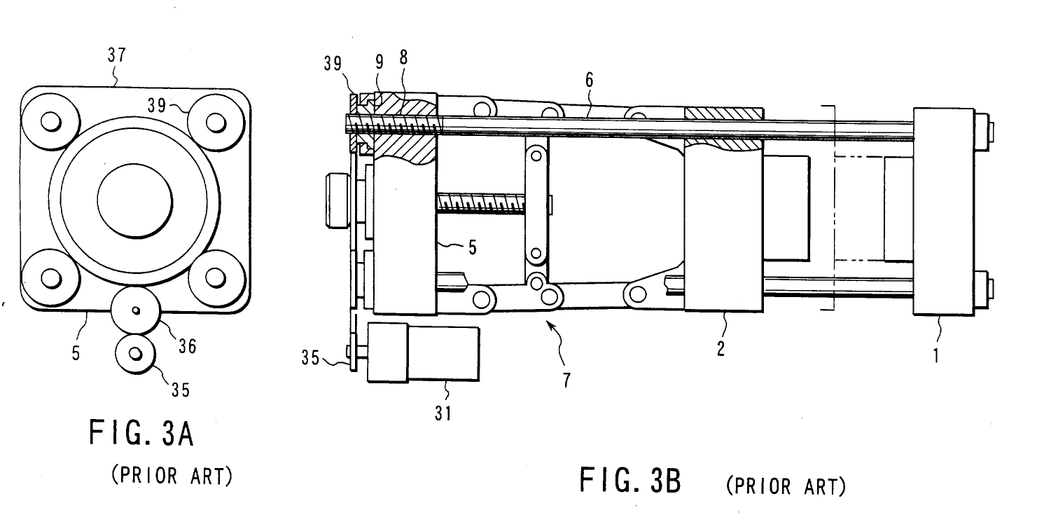

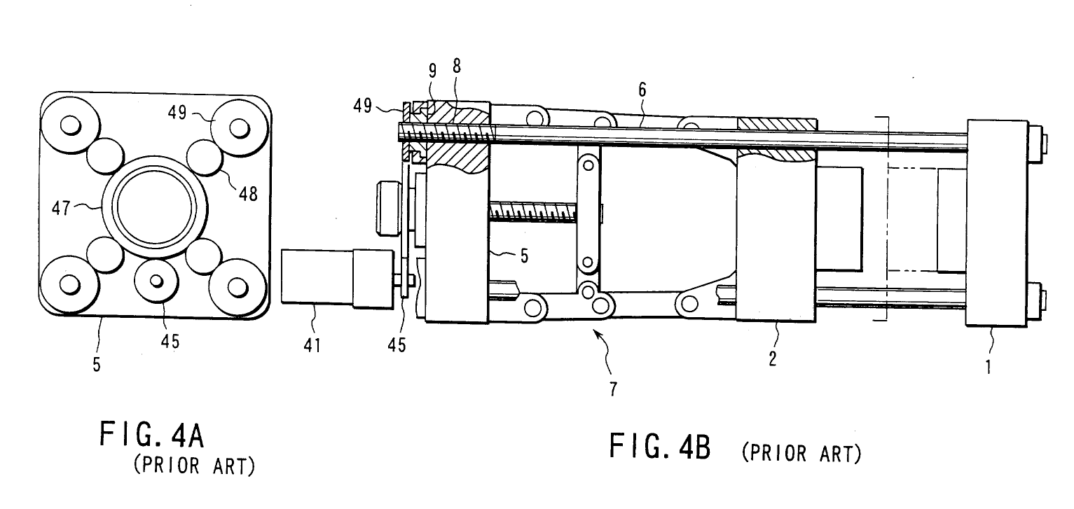

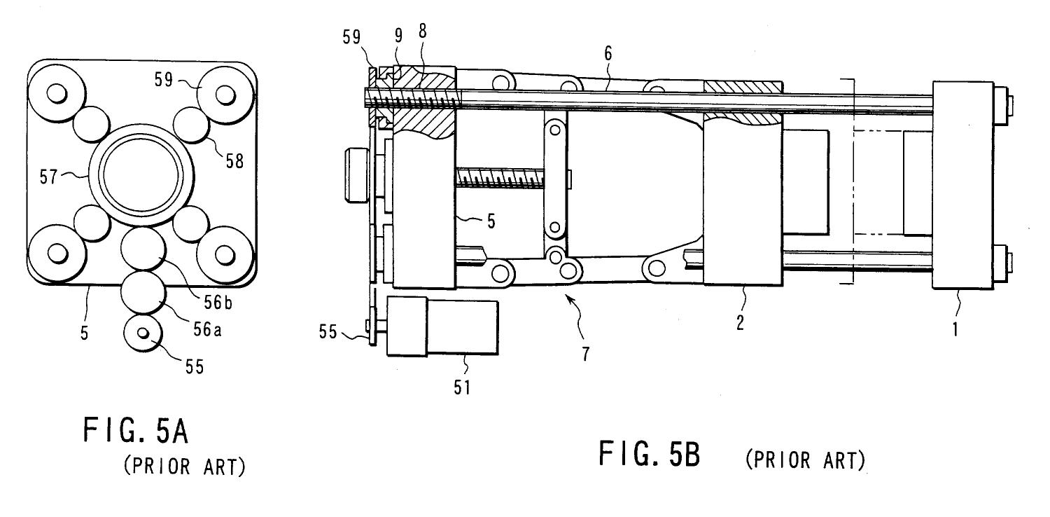

FIGS. 1A and 1B show one embodiment of a structure schematically showing a die clamping unit of an injection molding machine according to the present invention. In these Figures, reference numeral 1 shows a stationary platen; 2; a movable platen; 3, a stationary die; 4, a movable die; 5, a link housing (housing); 6, tie bars; 7, a toggle mechanism (loading device for die clamping); 8, male screws of feed screw mechanisms; 9; nuts of the feed screw mechanisms; 11, a geared motor; 12, a first sprocket; 13, a chain; 14, a second sprocket; 15, a first spur gear; 17, a ring gear; 18, idle gears; and 19, second spur gears. It is to be noted that the present die clamping unit is different from the conventional die clamping unit shown in FIGS. 2A and 2B only in terms of a structure of a mechanism for transmitting a drive force to the nuts 9 of the feed screw mechanisms, and any further explanation is omitted with the same reference numerals employed here to designate common parts or elements corresponding to those shown in FIGS. 2A and 2B.

In the present embodiment, connection is made between each of the nuts 9 of the feed screw mechanisms and the geared motor 11 (serving as a drive source) through one common chain 13 and one common ring gear 17 as will be set out below. That is, the geared motor 11 is mounted on the lower side of the link housing 5. At the back face of the link housing 5 the first spur gear 15 is mounted rotatably. The first sprocket 12 is fixed to a drive shaft of the geared motor 11 and the second sprocket 14 is fixed to the shaft of the first spur gear 15, and a chain 13 is run between the first sprocket 12 and the second sprocket 14. The ring gear 17 is rotatably mounted at the center of the back face of the link housing 5 and the first spur gear 15 is directly engaged with this ring gear 17. Each of the second spur gears 19 is fixed to the back face of the respective nut 2 and the respective second spur gear 19 is connected to the ring gear 17 through the corresponding idle gear 18.

In this die clamping unit, by driving the feed screw mechanisms (8, 9) provided at connection areas between the link housing 5 and the tie bars 6, the link housing 5 is moved forward or backward relative to the stationary platen 1, thus adjusting the distance between the link housing 5 and the stationary platen 1. A rotation motion of the geared motor 11 serving as a drive source of the feed screw mechanisms (8, 9) is transmitted through a combination of paired sprockets 12, 14 and chain 13 to the first spur gear 15 and then from the first spur gear 15 to each of the nuts 9 of the feed screw mechanisms through the ring gear 17, respective idle gear 18 and corresponding second spur gear 19.

In the die clamping unit, the speed reduction ratio “η” is represented by the following equation.

η=η1×η2×η3

where

η1=the speed reduction ratio of the geared motor;

η2=the number of teeth of the second spur gear/the number of the first spur gear; and

η3=the number of teeth of the second sprocket/the number of teeth of the first sprocket.

Since, as set out above, the speed reduction ratio η as a whole can also be adjusted by the ratio η3 of the number of the teeth of the sprocket 12 and that of the sprocket 14, it is possible to reduce the value of the reduction ratio η2 required for the geared motor 11.

According to the die clamping unit of the injection molding machine of the present invention, drive force is transmitted to the respective nut of the feed screw mechanisms through a combination of one common chain and one common ring gear, it is possible to accurately drive the feed screw mechanisms at the same speed. By making connection between the ring gear and the second spur gears through the idle gears it is not necessary to make the diameter of the ring gear greater, thus the manufacturing cost of the ring gear can be suppressed to a lower level.

Further, by making connection between the drive shaft of the motor and the shaft of the first spur gear through a combination of the chain and paired sprockets, it is possible to take a greater speed reduction ratio between the motor and the first spur gear and no greater speed reduction ratio is required for the motor itself. It is, therefore, possible to use a geared motor of a low cost and a relatively small speed reduction ratio. Further, by the above-mentioned connection through the chain it is possible to arrange the motor on the upper side, on the lower side or on the lateral side of the housing and it is also possible to prevent an increase in the full length of the die clamping unit.

What is claimed is:

1. A die clamping unit of an injection molding machine comprising:
a stationary platen configured to retain a stationary die;
a movable platen arranged opposite to the stationary platen and configured to retain a movable die;
a housing arranged behind the movable platen and configured to support the movable platen from a back side through a loading device for die clamping;
a plurality of tie bars coupled between the stationary platen and the housing and each having one end fixed to the stationary platen and the other end portion having a male thread of a feed screw mechanism, each of the tie bars being connected to the housing through the feed screw mechanism;
a plurality of nuts, each configured to be rotatably retained on the housing and fitted over the corresponding male thread to provide the feed screw mechanism;
a motor supported on the housing;
a first spur gear rotatably mounted to a back face of the housing;
a chain configured to be run between a first sprocket fixed to a drive shaft of the motor and a second sprocket fixed to a shaft of the first spur gear, and transmit a rotation motion of the motor to the first spur gear;
one ring gear rotatably mounted at a center of the back face of the housing and configured to be engaged with the first spur gear;
a plurality of second spur gears, each fixed to the corresponding nut; and
a plurality of idle gears, each provided between the ring gear and the respective spur gear, and configured to transmit a rotation motion of the ring gear to the corresponding second spur gear.
